(19) United States
(12) Patent Application Publication
(10) Pub. No.: US 2009/0031217 A1
(43) Pub. Date: Jan. 29, 2009

(54) Device and a Method for Generating Trademarks

(76) Inventor: Tom Tysbo, Oslo (NO)

Correspondence Address: BIRCH STEWART KOLASCH & BIRCH, PO BOX 747, FALLS CHURCH, VA, 22040-0747, US

(21) Appl. No.: 12/224,565

(22) PCT Filed: May 9, 2007
(86) PCT No.: PCT/NO2007/000164

§ 371 Date: Aug. 29, 2008

(30) Foreign Application Priority Data
May 16, 2006 (NO) 20062220

(51) Int. Cl. G06F 17/27; G06Q 10/00

(52) U.S. Cl. 715/256

(57) ABSTRACT

System and method for generating trademarks, comprising reception of a input signal (13) from a user, random selection of a character set from one of the user selected list (L1, L2, L3, L4) which constitutes a number of character sets, where each character set consists of one or more characters, combination of said selected character set with at least one second character set for generating a character sequence, and displaying of these on a display means (15).

The present application relates to a device and a method for generating trademarks according to the ingress of claim 1 and claim 8, respectively.

There exist word generators that generate more or less random words of up to a given maximum number of letters. However, among these words it will be a large number of useless words because the letters are put together by “impossible” letter combinations. It is therefore a large job to go through all the suggestions and pick out the ones that are suitable as trademarks.

There exist also word generators that put together prefix and suffix from a list of suchlike. Indeed, this gives, broadly speaking, words that are possible to pronounce, but on the expense of a very limited possibility of variation. An example on such a generator is the surname generator from the Patent-och registreringsverket.

It is therefore a need for a trademark generator that gives large possibilities of variation of words but that doesn't also generate an excess of hopeless word combinations. The present invention aims to provide such a generator.

It is also an objective to provide an appropriate control of the generator, so that the user can carry out active selections in the process and control which letters, characters and combinations of these that will enter into the trademarks.

These objectives are obtained by a system and a method as stated above, and characterized as stated in the independent claims.

In its simplest embodiment, the generator gives the user the possibility of selecting the placing of consonants and vowels in the word.

In a further embodiment, the generator gives the user the possibility of also selecting where he wants to place the diphthongs in the word.

In yet a further embodiment, the generator gives the possibility for where he wants to place ordinary combinations of consonants (e.g. st, ft, rd and sk).

In yet a further embodiment, the generator gives the user the possibility of selecting a prefix in front of the word and/or a suffix after the word.

In yet a further embodiment, the generator gives the user the possibility of placing words he wants to further consider in a list.

The invention will now be explained in more detail with reference to the accompanying drawings, where

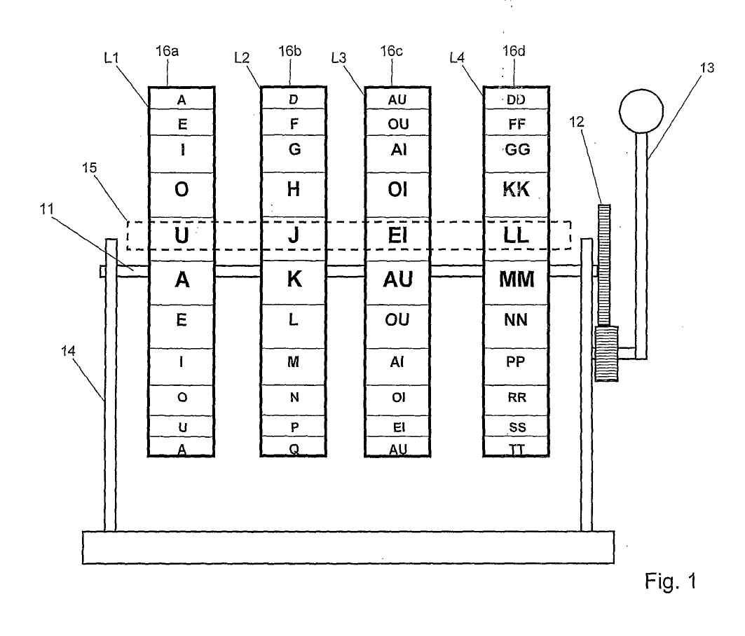

FIG. 1 illustrates a mechanical device according to the invention.

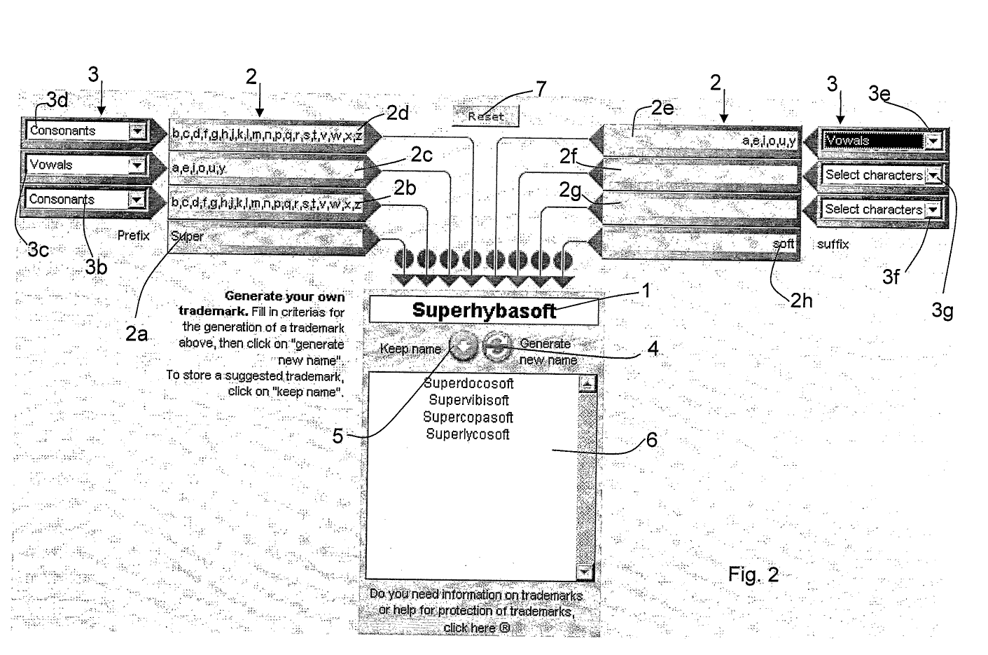

FIG. 2 illustrates a user interface by an example embodiment of the present invention.

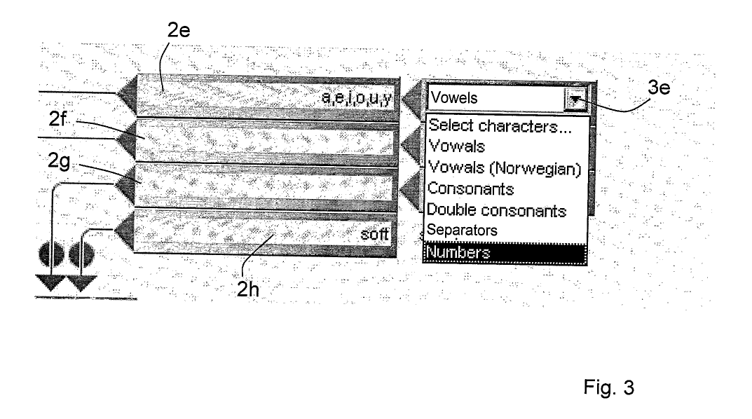

FIG. 3 shows a section of the user interface in FIG. 2.

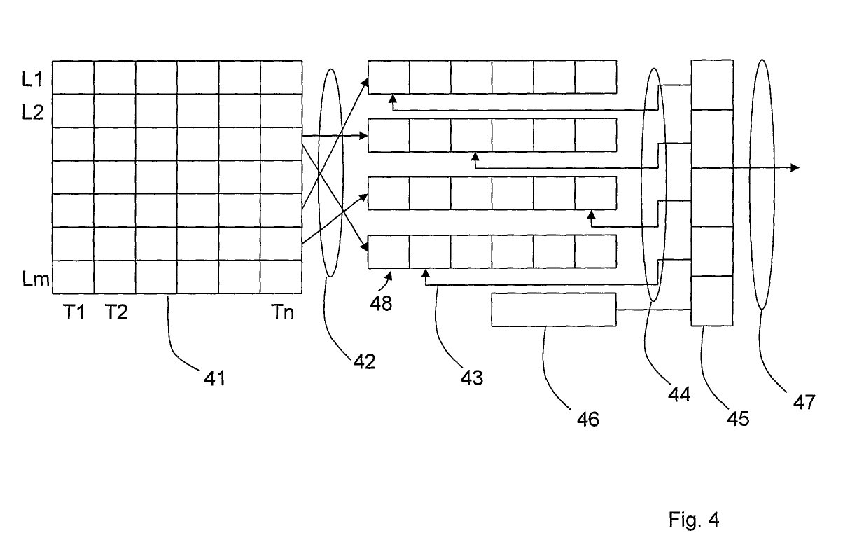

FIG. 4 shows a flow diagram of the method according to the invention.

In a simple embodiment the generator can be realized in a mechanical way, as outlined in FIG. 1. A number of wheels 16a, 16b, 16c, 16d, that each comprises a list L1, L2, L3, L4 of character sets, can be mounted side by side on a shaft 11, which is rotateably stored in a rack 14. The wheels 16a, 16b, 16c, 16d are stored so that they are pulled by the shaft 11 when this is sat in motion in one of its rotational directions and continues to rotate freely about the shaft 11 also after this has stopped. This can be obtained by a ratchet mechanism that will be well known for every mechanic.

Along its outer edge, the wheels 16a, 16b, 16c, 16d in FIG. 1 are equipped with character sets on the form of letters. By equipping some wheels 16b with consonants and some wheels 16a with vowels, the user can select to put together wheels on a shaft so that the consonant and vowel wheels is placed in a way that he wants the consonants and vowels in the words he wants to generate. In the showed example, the wheel 16c is equipped with diphthongs and the wheel 16d with double consonants. The shaft stands via a gear transmission 12 in connection with a handle 13. When the wheels 16a, 16b, 16c, 16d are placed after desire, the user can spin these by pulling the handle 13 and wait until the wheels 16a, 16b, 16c, 16d stops as a result of friction. The wheels will naturally have different friction against the shaft 11, so that they will spin different revolutions around this before they stop. Possibly, a stop mechanism (not shown) can be arranged that stops the wheels after a certain amount of time. When the wheels 16a, 16b, 16c, 16d has stopped, it will be formed a word of the letters lying on the same line 15. This appears by that the friction and the marked line contributes to combine the characters and display the trademark. With that, a random word based on the users' selection of lists/wheels with character sets appears, as in the shown example is “UJEILL”. It will also appear words of the letters that are on lines above or under the line that is facing the user, as shown i.a. the words “OHOIKK” and “AKAUMM” appear. The user can then make note of the words he wants to use in his further work to generate a trademark.

To be able to vary the list L1, L2, L3, L4 of character sets on the wheels 16a, 16b, 16c, 16d they can be supplied with loose character sets attachable to the wheels by Velcro, glue, magnets or something similar.

FIG. 1 shows only the principle for an example of a mechanical embodiment of the present invention. The mechanics for setting the wheels in motion and stop these on a random place can be built up in the same way as with a game machine of the type “one armed bandit”, as e.g. shown in GB 1262134. Since it is fewer vowels than consonants, one will appropriate adapt the vowel wheel in a way that the same vowel is placed multiple times along the circumference of the wheel than consonants, so that the vowel wheel and the consonant wheel preferably get an equal amount of characters.

Even though such a mechanical embodiment of the trademark generator according to the present invention is fully possible to both realize and use, it is more appropriate and more flexible to realize the invention by a computer. This also gives the possibility to realize increased functionality that is hard to realize by mechanics, e.g. to offer the trademark generator to a large amount of users via a communication network, such as the Internet.

FIG. 2 shows a user interface for a computer program that generates trademarks according to the present invention.

Reference number 1 refers to a field where the last generated trademark appears. The trademark in the field 1 is put together by the input form the user with assistance from parameter boxes 2, where the parameter box 2a indicates a prefix that the user can write in as optional text. The box 2a can also be empty. The parameter boxes 2b -2g indicates the user's selection of consonants or vowels. The user selects these with assistance from local menus 3. One can se here that the local menu 3b, that belongs to the parameter box 2b, is sat to consonants. Thus, the parameter box 2b contains only consonants. The local menu 3c is sat to vowels, and thus the accompanying parameter box 2c shows the vowels. In the local menus 3f and 3g it is not selected letters and the accompanying parameter boxes 2e and 2f are therefore blank.

It will be shortly referred to FIG. 3, that shows a section of the user interface in FIG. 2 with the local menu 3e being open. One can see here that the user has the choice between not only consonants and vowels, but also double consonants, separators (i.e. for example space, “/” and “-”) and numbers. In addition, there is a selection that includes the Norwegian vowels “æ”, “ø”, “å”.

In addition, it is also possible to include diphthongs (e.g. “ei”, “oi”, “au”) and regular consonant combinations (e.g. “st”, “rd”, “fr”).

If the user wants to exclude some of the letters either from the consonants or from the vowels (e.g. “c”, “w”, “x”, “z”), he can simply delete these directly in the parameter boxes 2b -2g. In these parameter boxes it is also possible to write ones own letter combinations in stead of the choices that the local menus 3b -3g gives.

In an alternative variant, a side menu for selection of language, for instance Lithuanian, can be available. A user can then choose Norwegian if he wants to include the Norwegian vowels “æ”, “ø”, “å” in the vowels and English if he doesn't want this. By such a menu it also becomes possible to generate trademarks with e.g. Cryllic or Greek characters.

It will now again be referred to the user interface in FIG. 2. In the last parameter box 2h, the user can write an optional suffix. In the same way as the prefix box 2a, this can also be blank.

When the user has set the parameter boxes after his own desire, he can push the button 4 which then starts the word generation. The computer program chooses then randomly a random letter among the letters that appear in the list in each of the parameter boxes 2b-2g. These letters are then combined, prefix and suffix are possibly added, and the final word is presented in the trademark field 1. In the shown example, the trademark “superhybasoft” has been generated. If the user wants to keep this trademark for later evaluation, he can push the button 5. The trademark will then be transferred over to a list field 6. To this field 6, four other trademarks are already transferred. From the field 6, the list with trademarks can be copied to e.g. a word processing program.

It is also provided a button 7 to reset the choices in all the parameter boxes, e.g. if the user wants to generate a totally different trademark.

It is in addition to the functions that appear from the above mentioned, possible to couple the list in the field 6 to a database with registered trademarks, so that one can by a keystroke look up in the database on the trademarks in the list to check if the trademarks already are registered.

FIG. 4 illustrates the method according to a preferred embodiment of the invention. In this, the basis is in a matrix 41 of m lists L1-Lm. Each list can comprise a number of n character sets T1-Tn, where each character set can contain one or more characters. In the figure it is illustrated that all the lists contain the same number of character sets, but this can off course be selected. In its mechanical embodiment illustrated in FIG. 1, the lists will correspond to the wheels 16a, 16b, 16c, 16d, with a number of character sets placed along its circumference. The lists can both be pre-programmed categories 3e, equivalent to wheel 16a, 16b, 16c, 16d supplied with a number of character sets, e.g. containing vowels and diphthongs. Alternatively, a list can be made of the user for this opportunity, e.g. by written in a field 2a -2h (see FIG. 2) in an electronic user interface or by providing a wheel with selected letters or combinations of characters. As mentioned in connection with FIG. 2, a list already-made can also be edited by the user so that the user can control which character sets that can be selected and the probability for that one certain character set will be selected, e.g. by repeating a selected character set several times on the list.

By a user choice 42, the user can choose which lists 48, possibly via a category selection as in FIG. 3, that will be used to make the final trademark suggestion, and which order these will have. In FIG. 2, this is executed in a user interface where the fields 2a-2h can be selected in optional placings in the word, where these selections also give the order of the selected lists 48. In other embodiments, the selection of order can be done in other ways, e.g. by stating by each list which number it will have in sequence. In the mechanical version one can simply set the wheels in a wanted sequence. As illustrated, the same or equivalent lists will be possible to use several places in the expression. The order can also be set to be randomly selected.

From the till now selected lists 48, a randomly or stochastic selection 43 is performed from the character sets in each list. This selection can have an even distributed probability between the character sets or the weight so that each character set can give larger probability to be drawn. As mentioned, this can be obtained by repeating an element in the list so that one character set is repeated several times. The selected character sets are then put together with combining means 44 and displayed on display means 45, 15.

As illustrated by prefix 2a and suffix 2h in FIG. 2, a predetermined character set 46 can be inserted in a chosen place in the trademark that will be generated. This could also be obtained by letting one of the lists consist of only one character set, something that the user himself will be able to do in the step with list editing 42.

The finished suggestion of a trademark 45 can now be displayed 47, and the system can permit further handling 47, e.g. in an editor. The display 47 can also comprise electronic generation of speech to control how the trademark sounds, and can comprise visual aids, e.g. by selection of fonts to evaluate the appearance of the word.

In the electronic embodiment of the invention, the user interface can be coupled to an available trademark database that, automatically or on the users command, can compare the suggested trademark with the content of the database to control if the trademark is already registered. The equivalent can also be done with databases for domain name and the like.

To summarize, the invention is therefore related to in the preferred embodiment, to a system and a method for generating trademarks, comprising at least two selectors 2, 3 for registration of a selection from a user, of character sets comprising at least one or more characters. It comprises further a random mechanism 43 attached to at least one first of said selectors are arranged to a random selection of character sets form a list that constitutes of a number of character sets, combination means 45 for combining character sets from said selectors for creation of a sequence of characters, and display means 47 for displaying said character sequence.

The first selector can also comprise a category selector arranged to receive a choice form the user between a number of lists, where each list comprises a number of character sets within a predetermined category, e.g. consonants, vowels or diphthongs. As illustrated in FIGS. 2 and 3, this can happen at the users selection of a list of character set belonging to a category 3, this generate all the character sets in the actual list in an editable text box 2, where the user can add or remove selections not of current interest. A random choice from the edited list is then placed in the wanted position in the generated trademark suggestion.

The user interface in the electronic embodiment of the invention can be programmed by a person skilled in the art with several possible programming tools, and will not be described in detail here. The invention can also be performed as an electronic system of logical units that in a known way communicates with the user via a keyboard and a screen.

1-14. (canceled)

15. System for generating trademarks and the like, comprising:
a user interface (2, 3, 13) for receiving a selection from a user,
at least two selectors (2a-2h), which selectors are arranged to, based on said selection from the user, to be provided one or more character sets, each character set consist of one or more characters, and where at least one first selector is provided a list (L1-Lm) of character sets,
editing means arranged to let the user edit (i.e. delete, add, amend) character sets in said list.
a randomly mechanism related to each of said at least one first selector and arranged to a randomly selection of a character sets from said list (L1-Lm), so that each selector is provided one selected character set,
combination means (44) for combination of said selected character set for creation of a character sequence,
and display means (45, 15) for displaying said character sequence.

16. System according to claim 15, where said first selector comprises a category selector arranged to receive a selection from the user between a number of lists, where each list comprises a number of character sets within a predetermined category, e.g. consonants, vowels or diphthongs.

17. System according to claim 15, comprising editing means arranged to let users edit the combined sequence of characters.

18. System according to claim 15, where the random mechanism is arranged to weight the selection from predetermined criteria.

19. System according to claim 15, where the display means also comprises interactive selection means e.g. in the form of an interactive user interface on a computer, to let the user perform the said selections.

20. System according to claim 19, comprising a connection to a database containing an overview over registered trademarks, transfer means for transferring the displayed character sequence to said database for comparing of this with registered trademarks in the database, and to display the results of the examination to the user.

21. Method for generation of trademarks, comprising the following steps performed after reception of an input signal from a user:
random selection of a character set from one of the user selected list that constitutes a number of character sets, where each character sets comprises of one or more characters,
display of the character set in selected list in editing means arranged to let the user edit (i.e. delete, add, amend) character sets in said list
combination of said selected character set with at least a second character set for generation of a character sequence, and
displaying of these on a display means.

22. Method according to claim 21, where said random selections comprises selection in a category selector between a number of lists, where each list comprises a number of character sets within a predetermined category, e.g. consonants, vowels or diphthongs.

23. Method according to claim 21, comprising display of the combined character set in editing means arranged to let the user change the combined character sequence.

24. Method according to claim 21, controlling of the random mechanism by weighting of the selection from predetermined criteria.

25. Method according to claim 21, where the display means also comprises interactive selection means, e.g. in the form of an interactive user interface on a computer, to let the user perform the said selections.

26. Method according to claim 25, comprising transferring of the displayed character set to a database containing registered trademarks for comparison of the displayed character set with registered trademarks in the database, and to display the result of the examination to the user.
